(19) United States
(12) Patent Application Publication
(10) Pub. No.: US 2026/0020081 A1
(43) Pub. Date: Jan. 15, 2026

(54) POWER SAVING IN ULTRA-WIDE BAND (UWB) ENABLED CONNECTED DEVICES

(71) Applicant: QUALCOMM Incorporated, San Diego, CA (US)

(72) Inventors: Aman UNIYAL, Haldwani (IN); Visweswara TANUKU, Hyderabad (IN); Sumit GEMINI, Delhi (IN)

(21) Appl. No.: 18/768,905

(22) Filed: Jul. 10, 2024

(51) Int. Cl. H04W 76/10; H04B 1/7163; H04W 8/22; H04W 12/06

(52) U.S. Cl. CPC H04W 76/10; H04B 1/7163; H04W 8/22; H04W 12/06

(57) ABSTRACT

This disclosure provides methods, components, devices and systems for power saving in ultra-wide band (UWB) enabled connected devices. Some aspects more specifically relate to an authentication procedure at collocated devices. In some examples, a first wireless device may communicate via a first radio access technology (RAT) with a second device that is collocated with the first wireless device. The first wireless device may be capable of communicating with a third wireless device via a second RAT. The first wireless device may transmit, via the first RAT, a message to the second device that is indicative of a first status of communications between the first wireless device and the third wireless device via the second RAT. In some examples, the second wireless device may change a second status of communications between the second wireless device and the third wireless device based on reception of the message.

### TECHNICAL FIELD

This disclosure relates generally to wireless communication and, more specifically, to power saving in ultra-wide band (UWB) enabled connected devices.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first device. The method may include communicating via a first radio access technology (RAT) with a second device that is collocated with the first device, where the first device is capable of communicating with a third device via a second RAT that is different from the first RAT and transmitting, via the first RAT, a message to the second device that is indicative of a first status of communications between the first device and the third device via the second RAT.

Another innovative aspect of the subject matter described in this disclosure can be implemented in a first device for wireless communications. The first device may include a processing system that includes processor circuitry and memory circuitry that stores code. The processing system may be configured to cause the first device to communicate via a first RAT with a second device that is collocated with the first device, where the first device is capable of communicating with a third device via a second RAT that is different from the first RAT and transmit, via the first RAT, a message to the second device that is indicative of a first status of communications between the first device and the third device via the second RAT.

Another innovative aspect of the subject matter described in this disclosure can be implemented in a first device for wireless communications. The first device may include means for communicating via a first RAT with a second device that is collocated with the first device, where the first device is capable of communicating with a third device via a second RAT that is different from the first RAT and means for transmitting, via the first RAT, a message to the second device that is indicative of a first status of communications between the first device and the third device via the second RAT.

Another innovative aspect of the subject matter described in this disclosure can be implemented in a non-transitory computer-readable medium storing code for wireless communications. The code may include instructions executable by one or more processors to communicate via a first RAT with a second device that is collocated with the first device, where the first device is capable of communicating with a third device via a second RAT that is different from the first RAT and transmit, via the first RAT, a message to the second device that is indicative of a first status of communications between the first device and the third device via the second RAT.

Some examples of the method, first devices, and non-transitory computer-readable medium described herein may further include operations, features, means, or instructions for establishing a connection with the third device via the second RAT, where the message indicating the first status of communications between the first device and the third device may be based on establishing the connection between the first device and the third device.

In some examples of the method, first devices, and non-transitory computer-readable medium described herein, the message to the second device indicates that the first status of communications between the first device and the third device may be a connected status.

In some examples of the method, first devices, and non-transitory computer-readable medium described herein, establishing the connection with the third device may include operations, features, means, or instructions for authenticating with the third device based on an authentication key stored at one of the first device or the second device.

In some examples of the method, first devices, and non-transitory computer-readable medium described herein, the message may be indicative that the second device may be to refrain from establishing communications with the third device or may be to terminate current communications with the third device.

Some examples of the method, first devices, and non-transitory computer-readable medium described herein may further include operations, features, means, or instructions for refraining from establishing a connection with the third device via the second RAT, where the message indicating the first status of communication between the first device and the third device may be based on an absence of the connection between the first device and the third device.

Some examples of the method, first devices, and non-transitory computer-readable medium described herein may further include operations, features, means, or instructions for refraining from establishing the connection with the third device may be based on a battery status associated with the first device.

In some examples of the method, first devices, and non-transitory computer-readable medium described herein, the message to the second device indicates that the first status of communications between the first device and the third device may be an unconnected status.

In some examples of the method, first devices, and non-transitory computer-readable medium described herein, the message may be indicative that the second device may be to establish communications with the third device or may be to maintain current communications with the third device.

In some examples of the method, first devices, and non-transitory computer-readable medium described herein, the message includes one or more ranging parameters.

In some examples of the method, first devices, and non-transitory computer-readable medium described herein, the message may be a first message to the second device and the method, apparatuses, and non-transitory computer-readable medium may include further operations, features, means, or instructions for transmitting, via the first RAT and subsequent to transmission of the first message, a second message to the second device indicating a distance between the first device and the third device, or indicating a location of the third device, where the second message may be transmitted in an absence of communications between the second device and the third device.

In some examples of the method, first devices, and non-transitory computer-readable medium described herein, the first RAT includes a Bluetooth connection and the second RAT includes an ultra-wide band (UWB) connection.

One innovative aspect of the subject matter described in this disclosure can be implemented in a method for wireless communications by a first device. The method may include communicating via a first RAT with a second device that is collocated with the first device, where the first device is capable of communicating with a third device via a second RAT that is different from the first RAT, receiving, via the first RAT, a message from the second device that is indicative of a first status of communications between the second device and the third device via the second RAT, and changing a second status of communications between the first device and the third device via the second RAT based on reception of the message from the second device.

Another innovative aspect of the subject matter described in this disclosure can be implemented in a first device for wireless communications. The first device may include a processing system that includes processor circuitry and memory circuitry that stores code. The processing system may be configured to cause the first device to communicate via a first RAT with a second device that is collocated with the first device, where the first device is capable of communicating with a third device via a second RAT that is different from the first RAT, receive, via the first RAT, a message from the second device that is indicative of a first status of communications between the second device and the third device via the second RAT, and change a second status of communications between the first device and the third device via the second RAT based on reception of the message from the second device.

Another innovative aspect of the subject matter described in this disclosure can be implemented in a first device for wireless communications. The first device may include means for communicating via a first RAT with a second device that is collocated with the first device, where the first device is capable of communicating with a third device via a second RAT that is different from the first RAT, means for receiving, via the first RAT, a message from the second device that is indicative of a first status of communications between the second device and the third device via the second RAT, and means for changing a second status of communications between the first device and the third device via the second RAT based on reception of the message from the second device.

Another innovative aspect of the subject matter described in this disclosure can be implemented in a non-transitory computer-readable medium storing code for wireless communications. The code may include instructions executable by one or more processors to communicate via a first RAT with a second device that is collocated with the first device, where the first device is capable of communicating with a third device via a second RAT that is different from the first RAT, receive, via the first RAT, a message from the second device that is indicative of a first status of communications between the second device and the third device via the second RAT, and change a second status of communications between the first device and the third device via the second RAT based on reception of the message from the second device.

In some examples of the method, first devices, and non-transitory computer-readable medium described herein, changing the second status may include operations, features, means, or instructions for establishing a connection with the third device via the second RAT based on the message indicating that the first status of communications between the second device and the third device may be an unconnected status.

In some examples of the method, first devices, and non-transitory computer-readable medium described herein, establishing the connection with the third device may include operations, features, means, or instructions for authenticating with the third device based on an authentication key stored at one of the first device or the second device, where establishing the connection with the third device may be based on transmitting the second message.

In some examples of the method, first devices, and non-transitory computer-readable medium described herein, changing the second status may include operations, features, means, or instructions for disconnecting from a connection with the third device via the second RAT based on the message indicating that the first status of communications between the second device and the third device may be a connected status.

In some examples of the method, first devices, and non-transitory computer-readable medium described herein, the message includes one or more ranging parameters.

In some examples of the method, first devices, and non-transitory computer-readable medium described herein, the message may be a first message from the second device and the method, apparatuses, and non-transitory computer-readable medium may include further operations, features, means, or instructions for receiving, via the first RAT and subsequent to reception of the first message, a second message from the second device indicating a distance between the second device and the third device, or indicating a location of the third device, where the second message may be received in an absence of communications between the first device and the third device.

In some examples of the method, first devices, and non-transitory computer-readable medium described herein, the first RAT includes a Bluetooth connection and the second RAT includes an UWB connection.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a timing diagram illustrating an example process for performing a ranging operation.

FIG. 4 shows an example of a signaling diagram that supports power saving in ultra-wide band (UWB) enabled connected devices.

FIG. 5 shows an example of a process flow that supports power saving in UWB enabled connected devices.

FIG. 6 shows an example of a process flow that supports power saving in UWB enabled connected devices.

FIG. 7 shows a block diagram of an example wireless communication device that supports power saving in UWB enabled connected devices.

FIGS. 8 through 12 show flowcharts illustrating example processes performable by or at a first device that supports power saving in UWB enabled connected devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a first wireless device (such as a user equipment (UE)) and a second wireless device (such as a UE or smartwatch) may perform an authentication procedure with a third wireless device (such as a UE or vehicle to everything (V2X) device) via a first radio access technology (RAT) (such as an ultra-wide band (UWB) connection). In some examples, the first wireless device and the second wireless device may perform concurrent repetitive authentication procedures. That is, the third wireless device may authenticate the first wireless device or the second wireless device. The concurrent repetitive authentication procedures may decrease efficiency of wireless communication resources and increase power consumption at the first wireless device or second wireless device.

Various aspects relate generally to authenticating collocated wireless devices via the first RAT. Some aspects more specifically relate to control signaling indicating performance of an authentication procedure at a wireless device. In some examples, the first wireless device may transmit a message to the second wireless device indicating a status of communication between the first wireless device and the third wireless device. In some examples, the message may indicate for the second wireless device to refrain from performing the authentication procedure with the third wireless device. The first wireless device may perform the authentication procedure with the third wireless device based on transmitting the message indicating for the second wireless device to refrain from performing the authentication procedure. In some examples, the message may indicate for the second wireless device to perform the authentication procedure with the third wireless device. The first wireless device may refrain from performing the authentication procedure based on transmitting the message indicating for the second wireless device to perform the authentication procedure. Either the first wireless device or the second wireless device may perform an authentication procedure with the third wireless device based on communication via a second RAT (such as Bluetooth) between the first wireless device and the second wireless device.

Particular aspects of the subject matter described in this disclosure can be implemented to realize one or more of the following potential advantages. In some examples, by refraining from performing repetitive authentication procedures at the first wireless device and the second wireless device, the described techniques can be used to reduce power consumption at the first wireless device or the second wireless device and may increase efficient use of communication resources.

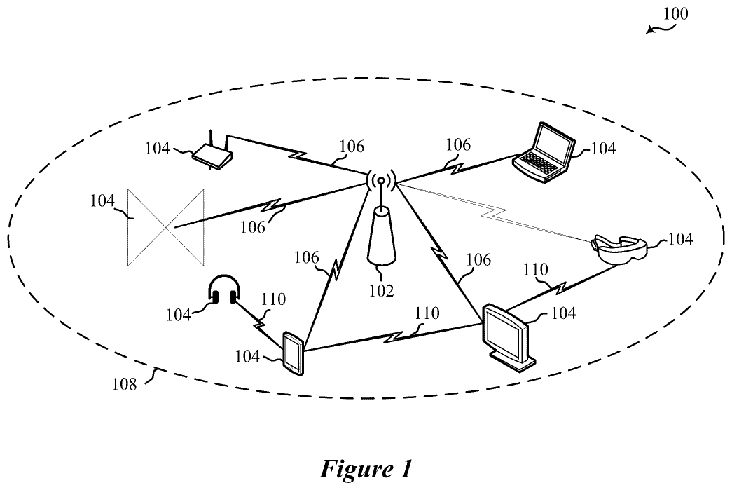

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

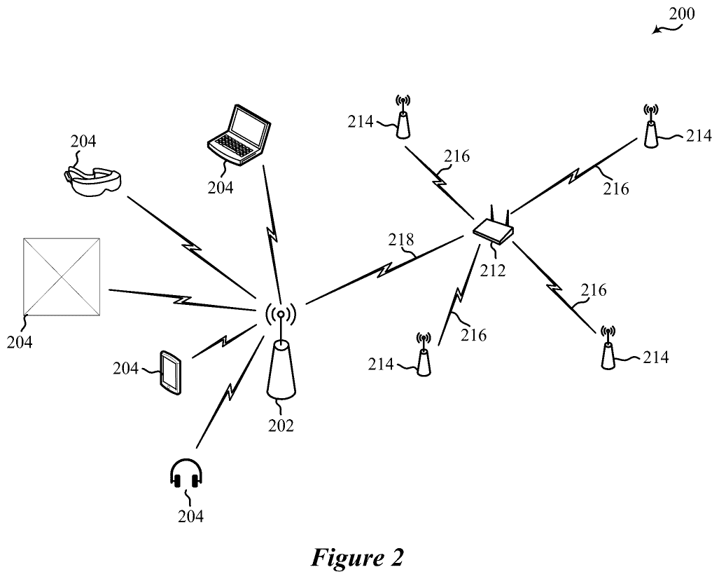

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

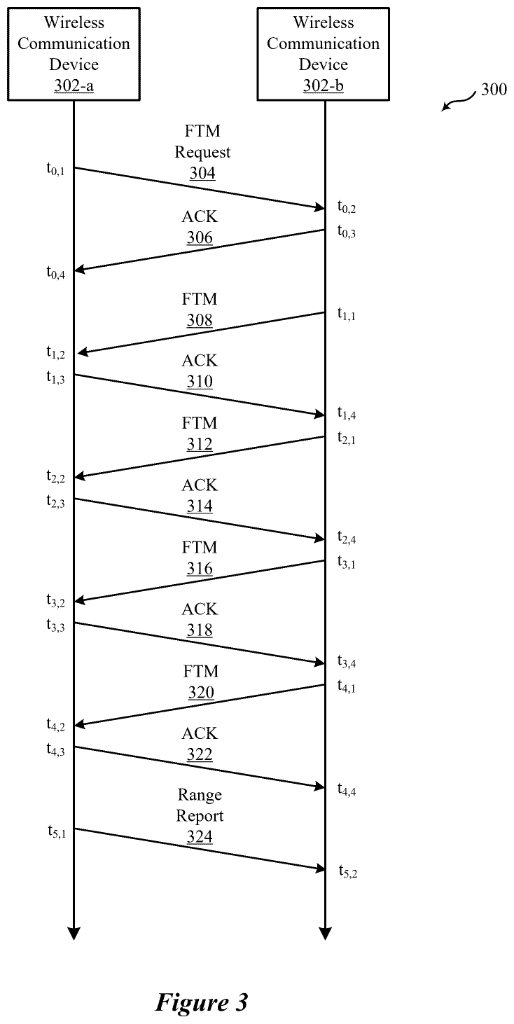

FIG. 3 shows a timing diagram illustrating an example process for performing a ranging operation 300. The process for the ranging operation 300 may be conjunctively performed by two wireless communication devices, such as a first wireless communication device 302-a and a second wireless communication device 302-b, in accordance with the IEEE 802.11REVme standards, which may each be an example of an AP 102 or a STA 104.

The ranging operation 300 may begin with the first wireless communication device 302-a transmitting an initial FTM range request frame 304 at time t_{0,1}. Responsive to successfully receiving the FTM range request frame 304 at time t_{0,2}, the second wireless communication device 302-b responds by transmitting a first ACK 306 at time t_{0,3}, which the first wireless communication device 302-a receives at time t_{0,4}. The first wireless communication device 302-a and the second wireless communication device 302-b exchange one or more FTM bursts, which may each include multiple exchanges of FTM action frames (hereinafter simply “FTM frames”) and corresponding ACKs. One or more of the FTM range request frame 304 and the FTM action frames (hereinafter simply “FTM frames”) may include FTM parameters specifying various characteristics of the ranging operation 300.

In the example shown in FIG. 3, in a first exchange, beginning at time t_{1,1}, the second wireless communication device 302-b transmits a first FTM frame 308. The second wireless communication device 302-b records the time t_{1,1} as the time of departure (TOD) of the first FTM frame 308. The first wireless communication device 302-a receives the first FTM frame 308 at time t_{1,2} and transmits a first acknowledgment frame (ACK) 310 to the second wireless communication device 302-b at time t_{1,3}. The first wireless communication device 302-a records the time t_{1,2} as the time of arrival (TOA) of the first FTM frame 308, and the time t_{1,3} as the TOD of the first ACK 310. The second wireless communication device 302-b receives the first ACK 310 at time t_{1,4} and records the time t_{1,4} as the TOA of the first ACK 310.

Similarly, in a second exchange, beginning at time t_{2,1}, the second wireless communication device 302-b transmits a second FTM frame 312. The second FTM frame 312 includes a first field indicating the TOD of the first FTM frame 308 and a second field indicating the TOA of the first ACK 310. The first wireless communication device 302-a receives the second FTM frame 312 at time t_{2,2} and transmits a second ACK 314 to the second wireless communication device 302-b at time t_{2,3}. The second wireless communication device 302-b receives the second ACK 314 at time t_{2,4}. Similarly, in a third exchange, beginning at time t_{3,1}, the second wireless communication device 302-b transmits a third FTM frame 316. The third FTM frame 316 includes a first field indicating the TOD of the second FTM frame 312 and a second field indicating the TOA of the second ACK 314. The first wireless communication device 302-a receives the third FTM frame 316 at time t_{3,2} and transmits a third ACK 318 to the second wireless communication device 302-b at time t_{3,3}. The second wireless communication device 302-b receives the third ACK 318 at time t_{3,4}. Similarly, in a fourth exchange, beginning at time t_{4,1}, the second wireless communication device 302-b transmits a fourth FTM frame 320. The fourth FTM frame 320 includes a first field indicating the TOD of the third FTM frame 316 and a second field indicating the TOA of the third ACK 318. The first wireless communication device 302-a receives the fourth FTM frame 320 at time t_{4,2} and transmits a fourth ACK 322 to the second wireless communication device 302-b at time t_{4,3}. The second wireless communication device 302-b receives the fourth ACK 322 at time t_{4,4}.

The first wireless communication device 302-a determines (such as obtains, identifies, ascertains, calculates, or computes) a range indication in accordance with the TODs and TOAs. For example, in implementations or instances in which an FTM burst includes four exchanges of FTM frames, the first wireless communication device 302-a may determine (such as obtain, identify, ascertain, calculate, or compute) a round trip time (RTT) between itself and the second wireless communication device III02-b in accordance with Equation 1.

$$RTT = \frac{1}{3} ( {\sum }_{k = 1}^{3} {t}_{4 , k} - {\sum }_{k = 1}^{3} {t}_{1 , k} ) - ( {\sum }_{k = 1}^{3} {t}_{3 , k} - {\sum }_{k = 1}^{3} {t}_{2 , k} ) \qquad ( 1 )$$

In some implementations, the range indication is the RTT. Additionally, or alternatively, in some implementations, the first wireless communication device 302-a may determine (such as obtain, identify, ascertain, calculate, or compute) an actual approximate distance between itself and the second wireless communication device 302-b, for example, by multiplying the RTT by an approximate speed of light in the wireless medium. In such instances, the range indication may additionally, or alternatively, include the distance value. Additionally, or alternatively, the range indication may include an indication as to whether the second wireless communication device 302-b is within a proximity (such as a service discovery threshold) of the first wireless communication device 302-a in accordance with the RTT. In some implementations, the first wireless communication device 302-a may transmit the range indication to the second wireless communication device 302-b, for example, in a range report 324 at time t_{5,1}, which the second wireless communication device receives at time t_{5,2}.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

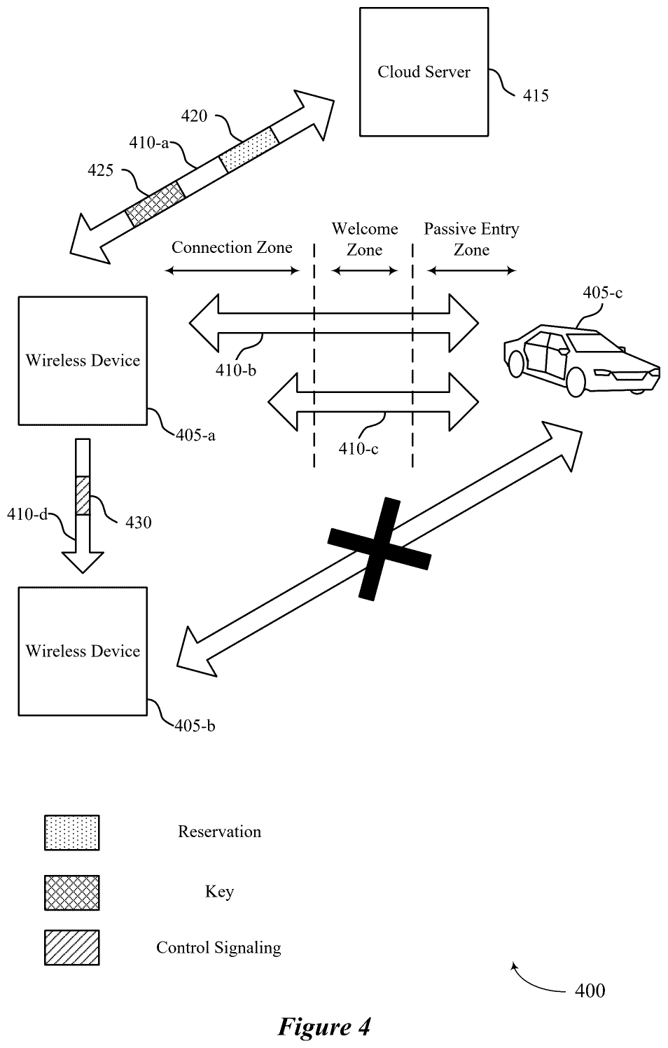

FIG. 4 shows an example of a signaling diagram 400 that supports power saving in UWB enabled connected devices. In some examples, signaling diagram 400 may implement aspects of wireless communication network 100. For example, a first wireless device 405-a, a second wireless device 405-b, or a third wireless device 405-c may represent examples of STAs, such as the STAs 104 described with reference to FIG. 1. The first wireless device 405-a and the second wireless device 405-b may be examples of UEs or wearables (such as a smart watch). The third wireless device may be an example of a V2X device (such as a V2X UE) or smart lock. The third wireless device may include one or more nodes on a vehicle (such as one or more transmitters or antennas).

In some wireless communications systems, the first wireless device 405-a and the second wireless device 405-b may be collocated. For example, the second wireless device 405-b (such as a wearable) may be worn by an individual for various purposes (such as playing music, videos, or games). That is, the first wireless device 405-a and the second wireless device 405-b may be the same distance away from the third wireless device 405-c. The wearable may connect or communicate with other IoT devices. A battery of the second wireless device 405-b (such as a smart watch battery) may support up to 500-600 milliampere-hour (mAH). The second wireless device 405-b may be configured to reduce power consumption to increase battery performance. The wireless devices 405 may support UWB signaling and Bluetooth or Bluetooth low energy (BLE) communications.

In some examples, the third wireless device may authenticate a candidate wireless device 405 (such as the first wireless device 405-a or the second wireless device 405-b). For example, the candidate wireless device 405 and the third wireless device 405-c may perform an authentication procedure. For example, the third wireless device 405-c may unlock one or more doors based on authenticating the candidate wireless device 405.

The authentication procedure may be based on a relative distance between the candidate wireless device 405 and the third wireless device 405-c. The wireless devices 405 may detect a relative distance between the wireless devices 405 via a BLE connection 410-b or UWB connection 410-c. For example, when the candidate wireless device 405 is in a connection zone (such as 50 or more meters) the candidate wireless device 405 may establish the BLE connection 410-b (such as a first RAT) with the third wireless device 405-c. The candidate wireless device 405 may communicate a message (such as an activation command or a status) with the third wireless device 405-c via the BLE connection 410-b. When the candidate wireless device 405 is in a welcome zone (such as six to ten meters), the candidate wireless device 405 may establish the UWB connection 410-c (such as a second RAT) with the third wireless device 405-c. The third wireless device 405-c may activate a welcome remote parking procedure. For example, the third wireless device 405-c may turn on a parking light based on establishing the UWB connection with the candidate wireless device 405. When the candidate wireless device 405 is in a passive entry zone (such as 3 or less meters), the third wireless device 405-c may perform an authorized procedure (such as unlock one or more doors). When the candidate wireless device 405 is in a passive start zone (not shown), the third wireless device 405-c may perform a second authorized procedure (such as start a vehicle). For example, FIG. 4 may illustrate a use case including UWB technology (such as car connectivity consortium enabled technology) used for unlocking a car for safety purposes.

The third wireless device 405-c may authenticate the candidate wireless device 405 based on the candidate wireless device 405 transmitting a key 425 via the BLE connection 410-b. For example, the candidate wireless device 405 may be associated with the third wireless device 405-c in a cloud server 415. The wireless device 405 may transmit a reservation 420 to the could server 415 via a wireless connection 410-a. The could server 415 may output a key 425 to the first wireless device 405-a. The candidate wireless device 405 may transmit the key 425 to the candidate wireless device 405, and the third wireless device 405-c may use the key 425 to authenticate the candidate wireless device 405.

For example, initially the first wireless device 405-a may be configured such that UWB is in an off state and BLE is in an on state. Once the first wireless device 405-a enters the connection zone, the BLE connection 410-b may be established between first wireless device 405-a (such as UE) and the third wireless device 405-c (such as car). Once the first wireless device 405-a enters the welcome zone, the first wireless device 405-a may turn on UWB signaling. The first wireless device 405-a may perform UWB ranging with the third wireless device and subsequently turn on the car engine (such as perform an authorized procedure).

If a user is carrying the first wireless device 405-a and wearing the second wireless device 405-b (such as a UWB enabled smart watch), the second wireless device 405-b may repeat the authentication procedure performed by the first wireless device 405-a. For example, the second wireless device 405-b may start UWB ranging with the third wireless device 405-c for unlocking one or more doors. The authentication procedure performed by the second wireless device 405-b may be redundant as the first wireless device 405-a may be already participating in an UWB ranging session with the third wireless device 405-c (such as for unlocking one or more doors). The repeated authentication procedures may increase power consumption at the second wireless device 405-b. Since the second wireless device 405-b may not aware that the first wireless device 405-a is already performing UWB ranging with the third wireless device 405-c (such as to unlock the car), power consumption is unnecessarily increased at the second wireless device 405-b.

In some examples, two collocated candidate wireless devices 405 (such as the first wireless device 405-a and the second wireless device 405-b) may both perform the authentication procedure with the third wireless device 405-c. For example, both the first wireless device 405-a and the second wireless device 405-b may start UWB ranging simultaneously for an authentication procedure (such as for unlocking the car), which may be redundant leading to unnecessary power consumption at the wireless devices 405. If the second wireless device 405-b receives information that the first wireless device 405-a is already participating in UWB ranging with the third wireless device 405-c (such as for unlocking one or more doors), the second wireless device 405-b may disable a respective UWB ranging session and reduce power consumption.

According to techniques described herein, the first wireless device 405-a may transmit a control signal 430 to the second wireless device 405-b indicating that the first wireless device 405-a is or will be participating in UWB ranging with the third wireless device 405-c. The second wireless device 405-b may not participate in UWB ranging with the third wireless device 405-c based on the control signal 430, reducing power consumption at the second wireless device 405-b. In some examples, the first wireless device 405-a may transmit a control signal 430 to the second wireless device 405-b indicating that the first wireless device 405-a will not participate in UWB ranging with the third wireless device 405-c. The second wireless device 405-b may participate in UWB ranging with the third wireless device 405-c based on the control signal 430, reducing power consumption at the first wireless device 405-a.

For example, the second wireless device 405-b may pair with the first wireless device 405-a (such as a phone) via a Bluetooth connection 410-d. The first wireless device 405-a and the second wireless device 405-b may be in continuous connection. When the first wireless device 405-a participates in UWB ranging, the first wireless device 405-a may notify the second wireless device 405-b about the session via the Bluetooth connection 410-d. For example, the first wireless device 405-a may transmit the control signal 430 including a ranging start indication and one or more ranging parameters (such as Msg<ranging started, ranging params>). The second wireless device 405-b may receive distance and location information of the third wireless device 405-c (such as the car) over the Bluetooth connection 410-d from the first wireless device 405-a. For example, the second wireless device 405-b may receive an indicate (such as control signal 430) that the paired first wireless device 405-a has already started UWB ranging with the third wireless device 405-c from the first wireless device 405-a. In some examples, the second wireless device 405-b may stop or terminate an UWB ranging session with the third wireless device 405-c if the second wireless device 405-b began the UWB ranging session. That is, once the second wireless device 405-b receives the control signal 430 (such as Msg<ranging started, ranging params>) from the first wireless device 405-a, the second wireless device 405-b may stop or terminate the UWB ranging session with the third wireless device 405-c. In some examples, the second wireless device 405-b may refrain from performing an UWB ranging session if the second wireless device 405-b had not begun the UWB ranging session. The first wireless device 405-a and the second wireless device 405-b may not perform parallel UWB ranging and may save power at the wireless devices 405.

In some examples, the control signal 430 may include an indication that the first wireless device 405-a will not perform UWB ranging with the third wireless device 405-c. For example, the first wireless device 405-a may transmit the control signal 430 indicating for the second wireless device 405-b to perform UWB ranging with the third wireless device 405-c. The control signal 430 may indicate for the second wireless device 405-b to perform UWB ranging with the third wireless device 405-c based on a battery constraint or a batter threshold at the first wireless device 405-a.

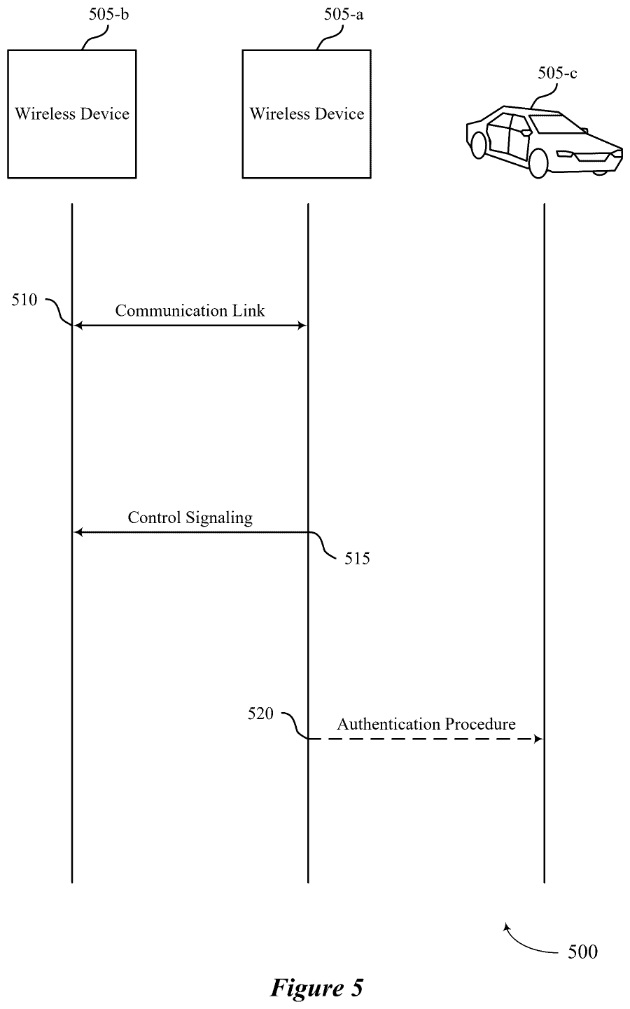

FIG. 5 shows an example of a process flow 500 that supports power saving in UWB enabled connected devices. In some examples, process flow 500 may implement aspects of, or be implemented by aspects of, the wireless communication network 100 or the signaling diagram 400. For example, a first wireless device 505-a may be an example of the first wireless device 405-a, and a second wireless device 505-b may be an example of the second wireless device 405-b as described with reference to FIG. 4. The third wireless device 505-c may be an example of the third wireless device 405-c as described with reference to FIG. 4.

At 510, the first wireless device 505-a may communicate via a first RAT (such as BLE) with the second wireless device 505-b that is collocated with the first wireless device 505-a. The first wireless device 505-a may be capable of communicating with a third wireless device 505-c via a second RAT (such as UWB) that is different from the first RAT. In some implementations, the first RAT may include a Bluetooth connection (such as such as the Bluetooth connection 410-d as described with reference to FIG. 4) and the second RAT may include an UWB connection (such as the UWB connection 410-c as described with reference to FIG. 4).

At 515, the first wireless device 505-a may transmit, via the first RAT, a message (such as a control signal) to the second device that is indicative of a first status of communications between the first wireless device 505-a and the third wireless device 505-c via the second RAT. In some examples, the message may include one or more ranging parameters.

In some implementations, the first wireless device 505-a may establish a connection with the third wireless device 505-c via the second RAT. The message indicating the first status of communications between the first wireless device 505-a and the third wireless device 505-c may be based on establishing the connection between the first wireless device 505-a and the third wireless device 505-c. The message to the second wireless device 505-b may indicate that the first status of communications between the first device and the third device is a connected status. For example, the first wireless device 505-a may indicate to the second wireless device 505-b, via the message, that the first wireless device 505-a is performing UWB ranging with the third wireless device 505-c. The message may be indicative that the second wireless device 505-b is to refrain from establishing communications with the third device 505-c or is to terminate current communications with the third wireless device 505-c.

In some implementations, the first wireless device 505-a may refrain from establishing a connection with the third wireless device 505-c via the second RAT. The message indicating the first status of communication between the first device and the third wireless device 505-c may be based on an absence of the connection between the first wireless device 505-a and the third wireless device 505-c. The first wireless device 505-a may refrain from establishing the connection with the third device based at least in part on a battery status associated with the first wireless device 505-a. The message to the second wireless device 505-b may indicate that the first status of communications between the first device and the third device is an unconnected status. The message may be indicative that the second wireless device 505-b is to establish communications with the third device 505-c or is to maintain current communications with the third wireless device 505-c.

In some implementations, the first wireless device 505-a may transmit, via the first RAT and subsequent to transmission of the first message, a second message to the second wireless device 505-b indicating a distance between the first wireless device 505-a and the third wireless device 505-c, or indicating a location of the third wireless device 505-c. The second message may be transmitted in an absence of communications between the second wireless device 505-b and the third wireless device 505-c.

At 520, the first wireless device 505-a may authenticate with the third device based on an authentication key stored at one of the first wireless device 505-a or the second wireless device 505-b.

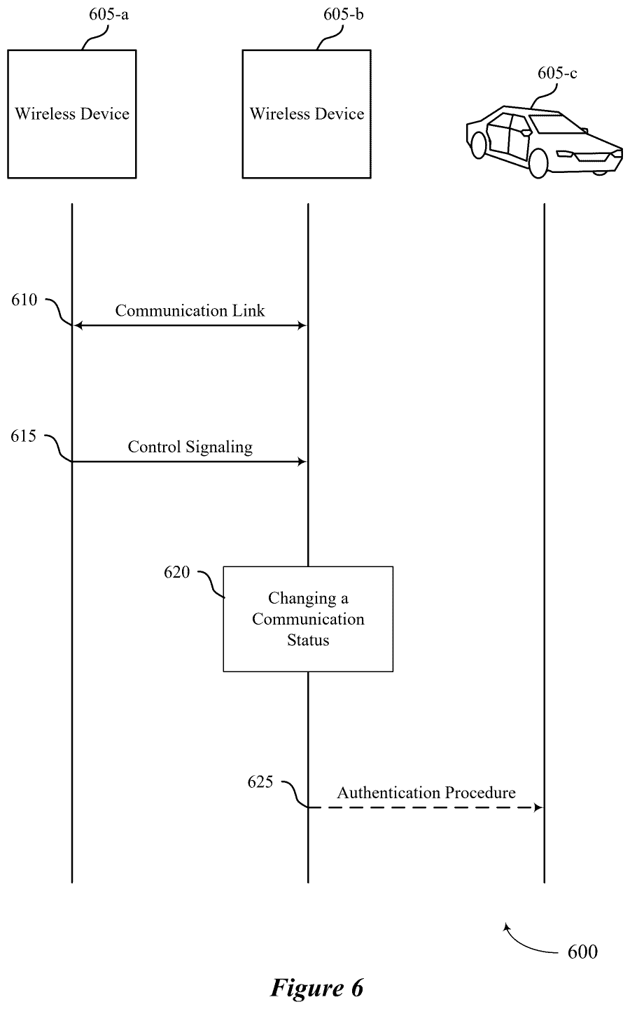

FIG. 6 shows an example of a process flow 600 that supports power saving in UWB enabled connected devices. In some examples, process flow 500 may implement aspects of, or be implemented by aspects of, the wireless communication network 100 or the signaling diagram 400. For example, a first wireless device 605-a may be an example of the first wireless device 405-a, and a second wireless device 605-b may be an example of the second wireless device 405-b as described with reference to FIG. 4. A third wireless device 605-c may be an example of the third wireless device 405-c as described with reference to FIG. 4.

At 610, the second wireless device 605-b may communicate via a first RAT (such as Bluetooth) with a first wireless device 605-a that is collocated with the first device. The first device may be capable of communicating with a third wireless device 605-c via a second RAT (such as UWB) that is different from the first RAT. The first RAT may include a Bluetooth connection and the second RAT include an UWB connection.

At 615, the second wireless device 605-b may receive, via the first RAT, a message from the first wireless device 605-a that is indicative of a first status of communications between the first wireless device 605-a and the third wireless device 605-c via the second RAT. The message may include one or more ranging parameters.

At 620, the second wireless device 605-b may change a second status of communications between the second wireless device 605-b and the third wireless device 605-c via the second RAT based on reception of the message from the first wireless device 605-a.

In some implementations, the second wireless device 605-b may establish a connection with the third wireless device 605-c via the second RAT based on the message indicating that the first status of communications between the first wireless device 605-a and the third wireless device 605-c is an unconnected status.

In some implementation, the second wireless device 605-b may disconnect from a connection with the third wireless device 605-c via the second RAT based on the message indicating that the first status of communications between the first wireless device 605-a and the third wireless device 605-c is a connected status.

In some implementations, the second wireless device 605-b may receive, via the first RAT and subsequent to reception of the first message, a second message from the second device indicating a distance between the first wireless device 605-a and the third wireless device 605-c, or indicating a location of the third device. The second message may be received in an absence of communications between the first wireless device 605-a and the third wireless device 605-c.

At 625, the second wireless device 605-b may authenticate with the third wireless device 605-c based on an authentication key stored at one of the first wireless device 605-a or the second wireless device 605-b.

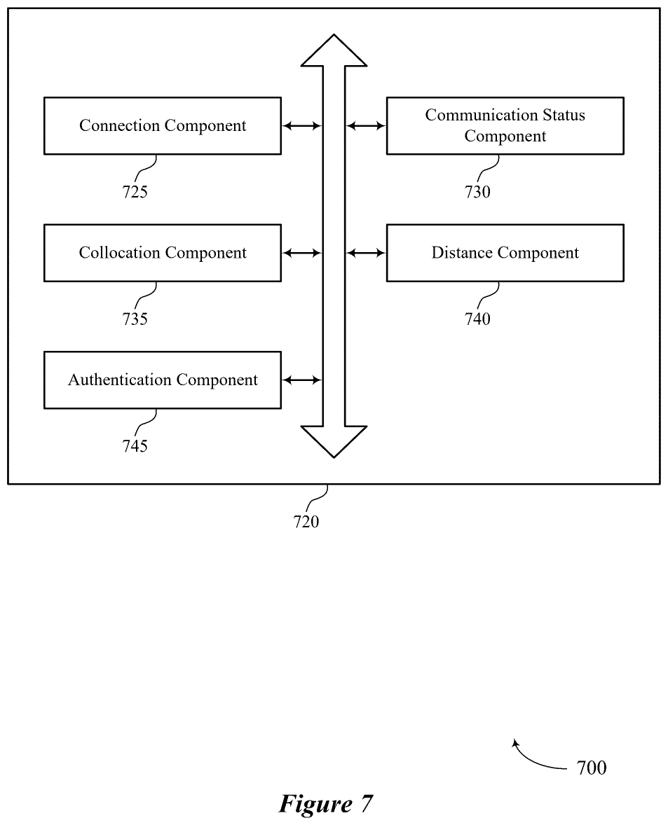

FIG. 7 shows a block diagram 700 of a wireless device 720 that supports power saving in UWB enabled connected devices. The wireless device 720 may be an example of aspects of a wireless device as described with reference to FIGS. 1 through 6. The wireless device 720, or various components thereof, may be an example of means for performing various aspects of power saving in UWB enabled connected devices as described herein. For example, the wireless device 720 may include a connection component 725, a communication status component 730, a collocation component 735, a distance component 740, an authentication component 745, or any combination thereof. Each of these components, or components or subcomponents thereof (such as one or more processors, one or more memories), may communicate, directly or indirectly, with one another (such as via one or more buses).

The wireless communication device 700 may support wireless communications in accordance with examples as disclosed herein. The connection component 725 is configurable or configured to communicate via a first RAT with a second device that is collocated with the first device, where the first device is capable of communicating with a third device via a second RAT that is different from the first RAT. The communication status component 730 is configurable or configured to transmit, via the first RAT, a message to the second device that is indicative of a first status of communications between the first device and the third device via the second RAT.

In some examples, the connection component 725 is configurable or configured to establish a connection with the third device via the second RAT, where the message indicating the first status of communications between the first device and the third device is based on establishing the connection between the first device and the third device.

In some examples, the message to the second device indicates that the first status of communications between the first device and the third device is a connected status.

In some examples, to support establishing the connection with the third device, the authentication component 745 is configurable or configured to authenticate with the third device based on an authentication key stored at one of the first device or the second device.

In some examples, the message is indicative that the second device is to refrain from establishing communications with the third device or is to terminate current communications with the third device.

In some examples, the connection component 725 is configurable or configured to refrain from establishing a connection with the third device via the second RAT, where the message indicating the first status of communication between the first device and the third device is based on an absence of the connection between the first device and the third device.

In some examples, refraining from establishing the connection with the third device is based on a battery status associated with the first device.

In some examples, the message to the second device indicates that the first status of communications between the first device and the third device is an unconnected status.

In some examples, the message is indicative that the second device is to establish communications with the third device or is to maintain current communications with the third device.

In some examples, the message includes one or more ranging parameters.

In some examples, the message is a first message to the second device, and the distance component 740 is configurable or configured to transmit, via the first RAT and subsequent to transmission of the first message, a second message to the second device indicating a distance between the first device and the third device, or indicating a location of the third device, where the second message is transmitted in an absence of communications between the second device and the third device.

In some examples, the first RAT includes a Bluetooth connection and the second RAT includes an ultra-wide band connection.

Additionally, or alternatively, the wireless communication device 700 may support wireless communications in accordance with examples as disclosed herein. The collocation component 735 is configurable or configured to communicate via a first RAT with a second device that is collocated with the first device, where the first device is capable of communicating with a third device via a second RAT that is different from the first RAT. In some examples, the communication status component 730 is configurable or configured to receive, via the first RAT, a message from the second device that is indicative of a first status of communications between the second device and the third device via the second RAT. In some examples, the connection component 725 is configurable or configured to change a second status of communications between the first device and the third device via the second RAT based on reception of the message from the second device.

In some examples, to support changing the second status, the connection component 725 is configurable or configured to establish a connection with the third device via the second RAT based on the message indicating that the first status of communications between the second device and the third device is an unconnected status.

In some examples, to support establishing the connection with the third device, the authentication component 745 is configurable or configured to authenticate with the third device based on an authentication key stored at one of the first device or the second device.

In some examples, to support changing the second status, the connection component 725 is configurable or configured to disconnect from a connection with the third device via the second RAT based on the message indicating that the first status of communications between the second device and the third device is a connected status.

In some examples, the message includes one or more ranging parameters.

In some examples, the message is a first message from the second device, and the distance component 740 is configurable or configured to receive, via the first RAT and subsequent to reception of the first message, a second message from the second device indicating a distance between the second device and the third device, or indicating a location of the third device, where the second message is received in an absence of communications between the first device and the third device.

In some examples, the first RAT includes a Bluetooth connection and the second RAT includes an ultra-wide band connection.

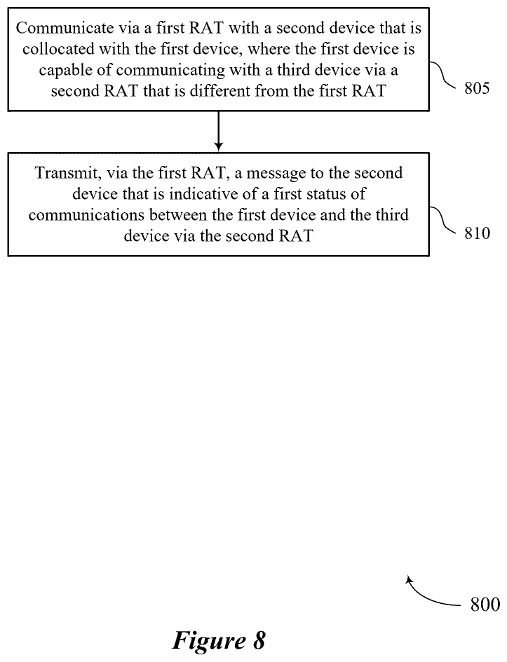

FIG. 8 shows a flowchart illustrating a method 800 that supports power saving in UWB enabled connected devices. The operations of the method 800 may be implemented by a wireless device or its components as described herein. For example, the operations of the method 800 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 805, the method may include communicating via a first RAT with a second device that is collocated with the first device, where the first device is capable of communicating with a third device via a second RAT that is different from the first RAT. The operations of 805 may be performed in accordance with examples as disclosed herein. In some examples, aspects of the operations of 805 may be performed by a connection component 725 as described with reference to FIG. 7.

At 810, the method may include transmitting, via the first RAT, a message to the second device that is indicative of a first status of communications between the first device and the third device via the second RAT. The operations of 810 may be performed in accordance with examples as disclosed herein. In some examples, aspects of the operations of 810 may be performed by a communication status component 730 as described with reference to FIG. 7.

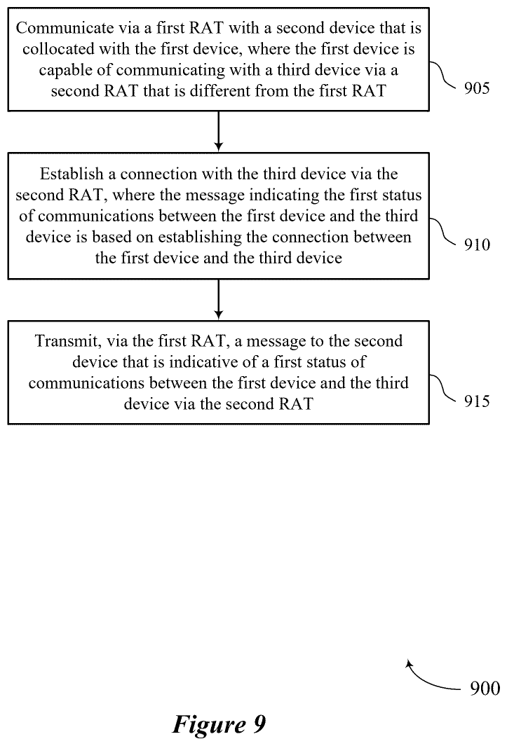

FIG. 9 shows a flowchart illustrating a method 900 that supports power saving in UWB enabled connected devices. The operations of the method 900 may be implemented by a wireless device or its components as described herein. For example, the operations of the method 900 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 905, the method may include communicating via a first RAT with a second device that is collocated with the first device, where the first device is capable of communicating with a third device via a second RAT that is different from the first RAT. The operations of 905 may be performed in accordance with examples as disclosed herein. In some examples, aspects of the operations of 905 may be performed by a connection component 725 as described with reference to FIG. 7.

At 910, the method may include establishing a connection with the third device via the second RAT, where the message indicating the first status of communications between the first device and the third device is based on establishing the connection between the first device and the third device. The operations of 910 may be performed in accordance with examples as disclosed herein. In some examples, aspects of the operations of 910 may be performed by a connection component 725 as described with reference to FIG. 7.

At 915, the method may include transmitting, via the first RAT, a message to the second device that is indicative of a first status of communications between the first device and the third device via the second RAT. The operations of 915 may be performed in accordance with examples as disclosed herein. In some examples, aspects of the operations of 915 may be performed by a communication status component 730 as described with reference to FIG. 7.

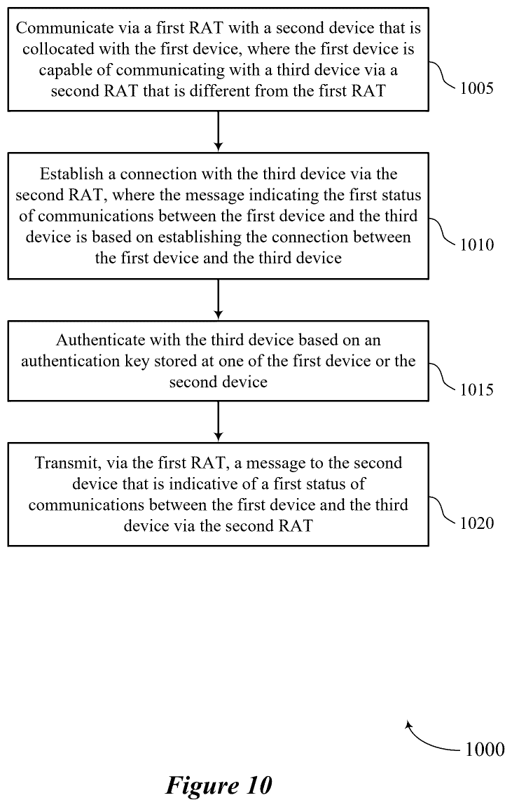

FIG. 10 shows a flowchart illustrating a method 1000 that supports power saving in UWB enabled connected devices. The operations of the method 1000 may be implemented by a wireless device or its components as described herein. For example, the operations of the method 1000 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 1005, the method may include communicating via a first RAT with a second device that is collocated with the first device, where the first device is capable of communicating with a third device via a second RAT that is different from the first RAT. The operations of 1005 may be performed in accordance with examples as disclosed herein. In some examples, aspects of the operations of 1005 may be performed by a connection component 725 as described with reference to FIG. 7.

At 1010, the method may include establishing a connection with the third device via the second RAT, where the message indicating the first status of communications between the first device and the third device is based on establishing the connection between the first device and the third device. The operations of 1010 may be performed in accordance with examples as disclosed herein. In some examples, aspects of the operations of 1010 may be performed by a connection component 725 as described with reference to FIG. 7.

At 1015, the method may include authenticating with the third device based on an authentication key stored at one of the first device or the second device. The operations of 1015 may be performed in accordance with examples as disclosed herein. In some examples, aspects of the operations of 1015 may be performed by an authentication component 745 as described with reference to FIG. 7.

At 1020, the method may include transmitting, via the first RAT, a message to the second device that is indicative of a first status of communications between the first device and the third device via the second RAT. The operations of 1020 may be performed in accordance with examples as disclosed herein. In some examples, aspects of the operations of 1020 may be performed by a communication status component 730 as described with reference to FIG. 7.

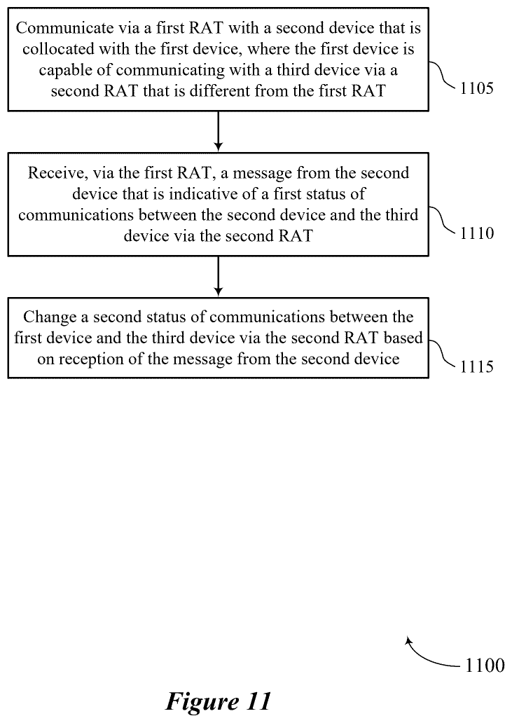

FIG. 11 shows a flowchart illustrating a method 1100 that supports power saving in UWB enabled connected devices. The operations of the method 1100 may be implemented by a wireless device or its components as described herein. For example, the operations of the method 1100 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 1105, the method may include communicating via a first RAT with a second device that is collocated with the first device, where the first device is capable of communicating with a third device via a second RAT that is different from the first RAT. The operations of 1105 may be performed in accordance with examples as disclosed herein. In some examples, aspects of the operations of 1105 may be performed by a collocation component 735 as described with reference to FIG. 7.

At 1110, the method may include receiving, via the first RAT, a message from the second device that is indicative of a first status of communications between the second device and the third device via the second RAT. The operations of 1110 may be performed in accordance with examples as disclosed herein. In some examples, aspects of the operations of 1110 may be performed by a communication status component 730 as described with reference to FIG. 7.

At 1115, the method may include changing a second status of communications between the first device and the third device via the second RAT based on reception of the message from the second device. The operations of 1115 may be performed in accordance with examples as disclosed herein. In some examples, aspects of the operations of 1115 may be performed by a connection component 725 as described with reference to FIG. 7.

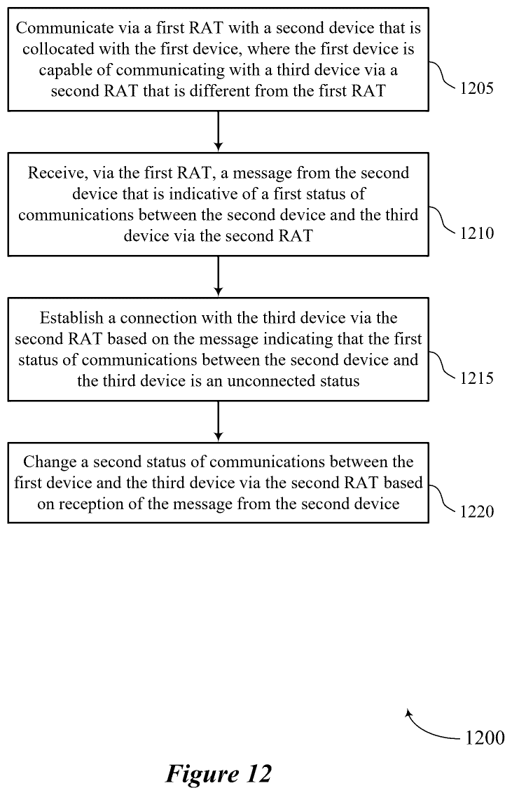

FIG. 12 shows a flowchart illustrating a method 1200 that supports power saving in UWB enabled connected devices. The operations of the method 1200 may be implemented by a wireless device or its components as described herein. For example, the operations of the method 1200 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 1205, the method may include communicating via a first RAT with a second device that is collocated with the first device, where the first device is capable of communicating with a third device via a second RAT that is different from the first RAT. The operations of 1205 may be performed in accordance with examples as disclosed herein. In some examples, aspects of the operations of 1205 may be performed by a collocation component 735 as described with reference to FIG. 7.

At 1210, the method may include receiving, via the first RAT, a message from the second device that is indicative of a first status of communications between the second device and the third device via the second RAT. The operations of 1210 may be performed in accordance with examples as disclosed herein. In some examples, aspects of the operations of 1210 may be performed by a communication status component 730 as described with reference to FIG. 7.

At 1215, the method may include establishing a connection with the third device via the second RAT based on the message indicating that the first status of communications between the second device and the third device is an unconnected status. The operations of 1215 may be performed in accordance with examples as disclosed herein. In some examples, aspects of the operations of 1215 may be performed by a connection component 725 as described with reference to FIG. 7.

At 1220, the method may include changing a second status of communications between the first device and the third device via the second RAT based on reception of the message from the second device. The operations of 1220 may be performed in accordance with examples as disclosed herein. In some examples, aspects of the operations of 1220 may be performed by a connection component 725 as described with reference to FIG. 7.

The following provides an overview of aspects of the present disclosure:
Aspect 1: A method for wireless communications at a first device, comprising: communicating via a first RAT with a second device that is collocated with the first device, wherein the first device is capable of communicating with a third device via a second RAT that is different from the first RAT; and transmitting, via the first RAT, a message to the second device that is indicative of a first status of communications between the first device and the third device via the second RAT.
Aspect 2: The method of aspect 1, further comprising: establishing a connection with the third device via the second RAT, wherein the message indicating the first status of communications between the first device and the third device is based at least in part on establishing the connection between the first device and the third device.
Aspect 3: The method of aspect 2, wherein the message to the second device indicates that the first status of communications between the first device and the third device is a connected status.
Aspect 4: The method of any of aspects 2 through 3, wherein establishing the connection with the third device further comprises: authenticating with the third device based on an authentication key stored at one of the first device or the second device.
Aspect 5: The method of any of aspects 2 through 4, wherein the message is indicative that the second device is to refrain from establishing communications with the third device or is to terminate current communications with the third device.
Aspect 6: The method of aspect 1, further comprising: refraining from establishing a connection with the third device via the second RAT, wherein the message indicating the first status of communication between the first device and the third device is based at least in part on an absence of the connection between the first device and the third device.
Aspect 7: The method of aspect 6, wherein refraining from establishing the connection with the third device is based at least in part on a battery status associated with the first device.
Aspect 8: The method of any of aspects 6 through 7, wherein the message to the second device indicates that the first status of communications between the first device and the third device is an unconnected status.
Aspect 9: The method of any of aspects 6 through 8, wherein the message is indicative that the second device is to establish communications with the third device or is to maintain current communications with the third device.
Aspect 10: The method of any of aspects 1 through 9, wherein the message comprises one or more ranging parameters.

Aspect 11: The method of any of aspects 1 through 10, wherein the message is a first message to the second device, the method further comprising: transmitting, via the first RAT and subsequent to transmission of the first message, a second message to the second device indicating a distance between the first device and the third device, or indicating a location of the third device, wherein the second message is transmitted in an absence of communications between the second device and the third device.
Aspect 12: The method of any of aspects 1 through 11, wherein the first RAT comprises a Bluetooth connection and the second RAT comprises an ultra-wide band connection.
Aspect 13: A method for wireless communications at a first device, comprising: communicating via a first RAT with a second device that is collocated with the first device, wherein the first device is capable of communicating with a third device via a second RAT that is different from the first RAT; receiving, via the first RAT, a message from the second device that is indicative of a first status of communications between the second device and the third device via the second RAT; and changing a second status of communications between the first device and the third device via the second RAT based at least in part on reception of the message from the second device.
Aspect 14: The method of aspect 13, wherein changing the second status further comprises: establishing a connection with the third device via the second RAT based at least in part on the message indicating that the first status of communications between the second device and the third device is an unconnected status.
Aspect 15: The method of aspect 14, wherein establishing the connection with the third device further comprises: authenticating with the third device based on an authentication key stored at one of the first device or the second device, wherein establishing the connection with the third device is based at least in part on transmitting the second message.
Aspect 16: The method of aspect 13, wherein changing the second status further comprises: disconnecting from a connection with the third device via the second RAT based at least in part on the message indicating that the first status of communications between the second device and the third device is a connected status.
Aspect 17: The method of any of aspects 13 through 16, wherein the message comprises one or more ranging parameters.
Aspect 18: The method of any of aspects 13 through 17, wherein the message is a first message from the second device, the method further comprising: receiving, via the first RAT and subsequent to reception of the first message, a second message from the second device indicating a distance between the second device and the third device, or indicating a location of the third device, wherein the second message is received in an absence of communications between the first device and the third device.
Aspect 19: The method of any of aspects 13 through 18, wherein the first RAT comprises a Bluetooth connection and the second RAT comprises an ultra-wide band connection.
Aspect 20: A first device for wireless communications, comprising one or more memories storing processor-executable code, and one or more processors coupled with the one or more memories and individually or collectively operable to execute the code to cause the first device to perform a method of any of aspects 1 through 12.
Aspect 21: A first device for wireless communications, comprising at least one means for performing a method of any of aspects 1 through 12.
Aspect 22: A non-transitory computer-readable medium storing code for wireless communications, the code comprising instructions executable by one or more processors to perform a method of any of aspects 1 through 12.
Aspect 23: A first device for wireless communications, comprising one or more memories storing processor-executable code, and one or more processors coupled with the one or more memories and individually or collectively operable to execute the code to cause the first device to perform a method of any of aspects 13 through 19.
Aspect 24: A first device for wireless communications, comprising at least one means for performing a method of any of aspects 13 through 19.
Aspect 25: A non-transitory computer-readable medium storing code for wireless communications, the code comprising instructions executable by one or more processors to perform a method of any of aspects 13 through 19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,” or the equivalent in context, whatever it is that is “based on ‘a,” or “based at least in part on ‘a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first device, comprising:
a processing system that includes processor circuitry and memory circuitry that stores code, the processing system configured to cause the first device to:
communicate via a first radio access technology (RAT) with a second device that is collocated with the first device, wherein the first device is capable of communicating with a third device via a second RAT that is different from the first RAT; and
transmit, via the first RAT, a message to the second device that is indicative of a first status of communications between the first device and the third device via the second RAT.

2. The first device of claim 1, wherein the processing system is further configured to cause the first device to:
establish a connection with the third device via the second RAT, wherein the message indicating the first status of communications between the first device and the third device is based at least in part on establishing the connection between the first device and the third device.

3. The first device of claim 2, wherein the message to the second device indicates that the first status of communications between the first device and the third device is a connected status.

4. The first device of claim 2, wherein, to establish the connection with the third device, the processing system is further configured to cause the first device to:
authenticate with the third device based at least in part on an authentication key stored at one of the first device or the second device.

5. The first device of claim 2, wherein the message is indicative that the second device is to refrain from establishing communications with the third device or is to terminate current communications with the third device.

6. The first device of claim 1, wherein the processing system is further configured to cause the first device to:
refrain from establishing a connection with the third device via the second RAT, wherein the message indicating the first status of communication between the first device and the third device is based at least in part on an absence of the connection between the first device and the third device.

7. The first device of claim 6, wherein refraining from establishing the connection with the third device is based at least in part on a battery status associated with the first device.

8. The first device of claim 6, wherein the message to the second device indicates that the first status of communications between the first device and the third device is an unconnected status.

9. The first device of claim 6, wherein the message is indicative that the second device is to establish communications with the third device or is to maintain current communications with the third device.

10. The first device of claim 1, wherein the message comprises one or more ranging parameters.

11. The first device of claim 1, wherein the message is a first message to the second device, and the processing system is further configured to cause the first device to:
transmit, via the first RAT and subsequent to transmission of the first message, a second message to the second device indicating a distance between the first device and the third device, or indicating a location of the third device, wherein the second message is transmitted in an absence of communications between the second device and the third device.

12. The first device of claim 1, wherein the first RAT comprises a Bluetooth connection and the second RAT comprises an ultra-wide band connection.

13. A first device, comprising:
a processing system that includes processor circuitry and memory circuitry that stores code, the processing system configured to cause the first device to:
communicate via a first radio access technology (RAT) with a second device that is collocated with the first device, wherein the first device is capable of communicating with a third device via a second RAT that is different from the first RAT;
receive, via the first RAT, a message from the second device that is indicative of a first status of communications between the second device and the third device via the second RAT; and
change a second status of communications between the first device and the third device via the second RAT based at least in part on reception of the message from the second device.

14. The first device of claim 13, wherein, to change the second status, the processing system is further configured to cause the first device to:
establish a connection with the third device via the second RAT based at least in part on the message indicating that the first status of communications between the second device and the third device is an unconnected status.

15. The first device of claim 14, wherein, to establish the connection with the third device, the processing system is further configured to cause the first device to:
authenticate with the third device based on an authentication key stored at one of the first device or the second device.

16. The first device of claim 13, wherein, to change the second status, the processing system is further configured to cause the first device to:
disconnect from a connection with the third device via the second RAT based at least in part on the message indicating that the first status of communications between the second device and the third device is a connected status.

17. The first device of claim 13, wherein the message comprises one or more ranging parameters.

18. The first device of claim 13, wherein the message is a first message from the second device, and the processing system is further configured to cause the first device to:
receive, via the first RAT and subsequent to reception of the first message, a second message from the second device indicating a distance between the second device and the third device, or indicating a location of the third device, wherein the second message is received in an absence of communications between the first device and the third device.

19. The first device of claim 13, wherein the first RAT comprises a Bluetooth connection and the second RAT comprises an ultra-wide band connection.

20. A method for wireless communications at a first device, comprising:
communicating via a first radio access technology (RAT) with a second device that is collocated with the first device, wherein the first device is capable of communicating with a third device via a second RAT that is different from the first RAT; and
transmitting, via the first RAT, a message to the second device that is indicative of a first status of communications between the first device and the third device via the second RAT.
